(19) United States
(12) Patent Application Publication
(10) Pub. No.: US 2010/0042953 A1
(43) Pub. Date: Feb. 18, 2010

(54) METHOD, COMPUTER, AND COMPUTER PROGRAM FOR DISPLAYING A HIERARCHICAL NAVIGATION SCHEME

(76) Inventors: Douglas Albert Stewart, Albany, NY (US); John Ronald Burr, Salem, VA (US); Robert Turner, Salem, VA (US); Richard Shaw, Salem, VA (US); Alexey Lipatov, Albany, NY (US); Xueyan Dong, New Milford, CT (US)

Correspondence Address: General Electric Company;GE Global Patent Operation, PO Box 861, 2 Corporate Drive, Suite 648, Shelton, CT, 06484, US

(21) Appl. No.: 12/193,195

(22) Filed: Aug. 18, 2008

(51) Int. Cl. G06F 3/048

(52) U.S. Cl. 715/854

(57) ABSTRACT

A method, computer, and computer program for displaying user screens within a hierarchical navigation scheme are provided. A method includes generating a navigation tree including a plurality of nodes, wherein each node is at least one of a link to a user screen, a pointer to at least one parent node, and a link to a script. The method also includes generating a navigation bar including a plurality of node navigation tool buttons and a current path including at least a first node button representative of a currently selected first node, generating a child bar including at least the first node button, and displaying the navigation bar and the child bar within a user interface.

### BACKGROUND OF THE INVENTION

The subject matter disclosed herein relates generally to human-machine interfaces and, more specifically, to methods, computers, and computer programs for configuring and displaying a hierarchical relationship between user screens.

At least some known organizational systems arrange similar items according to each item's function and/or theme. For example, a set of items may be arranged hierarchically such that items with common functions or themes are grouped together under a common heading to form a navigation theme, such as a tree.

At least some known human-machine interfaces (HMIs) provide a navigation scheme that is configured by associating objects on displays with navigation actions. For example, at least some known HMIs enable a user to navigate through a multi-level menu such that for each item that is selected in a particular level, a new set of items is displayed within a sublevel. Each item may provide direct access to a function or logical location.

However, such navigation schemes often collapse to display only a designated root location such that navigation through the scheme requires a user to begin again at the root location and to traverse through multiple layers to reach a desired location. Moreover, traversing through such a scheme often uses considerable display space and effectively masks a current working document or image. Accordingly, it is desirable to provide a method for configuring and navigating a hierarchical navigation scheme for a HMI having a large set of user screens.

### BRIEF DESCRIPTION OF THE INVENTION

This Brief Description is provided to introduce a selection of concepts in a simplified form that are further described below in the Detailed Description. This Brief Description is not intended to identify key features or essential features of the claimed subject matter, nor is it intended to be used as an aid in determining the scope of the claimed subject matter.

In one aspect, a method is provided for displaying hierarchical information related to a plurality of user screens. The method includes generating a navigation tree including a plurality of nodes, wherein each node is at least one of a link to a user screen, a pointer to at least one parent node, and a link to a script. The method also includes generating a navigation bar including a plurality of node navigation tool buttons and a current path including at least a first node button representative of a currently selected first node, generating a child bar including at least the first node button, and displaying the navigation bar and the child bar within a user interface.

In another aspect, a computer for displaying a plurality of user screens through a human-machine interface (HMI) is provided. The computer is programmed to generate a navigation tree including a plurality of nodes, wherein each node is at least one of a link to a user screen, a pointer to at least one parent node, and a link to a script. The computer is also programmed to generate a navigation bar including a plurality of node navigation tool buttons and a current path including at least a first node button representative of a currently selected first node, generate a child bar including at least the first node button, and display the navigation bar and the child bar within a user interface.

In another aspect, a computer program is embodied on a computer readable medium for displaying a plurality of user screens through a human-machine interface (HMI). The program includes at least one code segment that generates a navigation tree including a plurality of nodes, wherein each node is at least one of a link to a user screen of the plurality of user screens, a pointer to at least one parent node, and a link to a script. The code segment also generates a navigation bar including a plurality of node navigation tool buttons and a current path including at least a first node button representative of a currently selected first node, generates a child bar including at least the first node button, and displays the navigation bar and the child bar within a user interface such that a display width of the navigation bar and a display width of the child bar are based on a number of displayed node buttons.

### BRIEF DESCRIPTION OF THE DRAWINGS

FIG. 1 is a simplified block diagram of an exemplary system;

FIG. 2 is an expanded block diagram of an exemplary embodiment of a system architecture of the system shown in FIG. 1;

FIG. 3 is a screenshot illustrating an exemplary configuration interface utilized by the system architecture shown in FIG. 2;

FIG. 4 is a screenshot illustrating an exemplary user interface utilized by the system architecture shown in FIG. 2; and

FIG. 5 is a flowchart illustrating an exemplary method utilized by the system architecture shown in FIG. 2.

### DETAILED DESCRIPTION OF THE INVENTION

A computing device or computer such as described herein has one or more processors or processing units and a system memory. The computer typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Aspects of the invention may be implemented with any number and organization of components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

As used herein, a node refers to a unit that forms a hierarchical navigation structure and includes information that identifies a user screen or a global system script.

As used herein, a processor may include any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

As used herein, a database may include any collection of data including hierarchical databases, relational databases, flat file databases, object-relational databases, object oriented databases, and any other structured collection of records or data that is stored in a computer system The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif., IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

Described in detail herein are exemplary embodiments of methods, computers, and computer programs that facilitate simplifying designing, configuring, and using a complex hierarchical navigation scheme for a human-machine interface (HMI) application. A simplified configuration interface facilitates time savings at system setup time. A simplified user interface facilitates additional time savings by providing a consistent and organized representation of the navigation scheme to an operator. A more consistent and organized representation of the navigation scheme facilitates faster access to any given location within the navigation scheme and may decrease the time necessary to learn the navigation functionality of the HMI.

Technical effects of the methods, computers, and computer programs described herein include at least one of (a) generating a navigation tree that includes a plurality of nodes such that each node is associated with a link to another node, a user screen, and/or a script for execution on a computer system or a machine; (b) generating a navigation bar that includes a plurality of navigation buttons, such as a back button, a forward button, a favorites list button, a recently displayed list button, and/or a path of a currently selected node; (c) generating a child bar that includes a set of sibling nodes to the currently selected node for quick access to nodes related to the selected node; (d) displaying the navigation bar and the child bar; and (e) displaying a user screen associated with the selected node or executing a script associated with the selected node.

The methods, computers, and computer programs herein are not limited to the specific embodiments described herein. For example, components of each system and/or steps of each method may be used and/or practiced independently and separately from other components and/or steps described herein. In addition, each component and/or step may also be used and/or practiced with other assembly packages and methods.

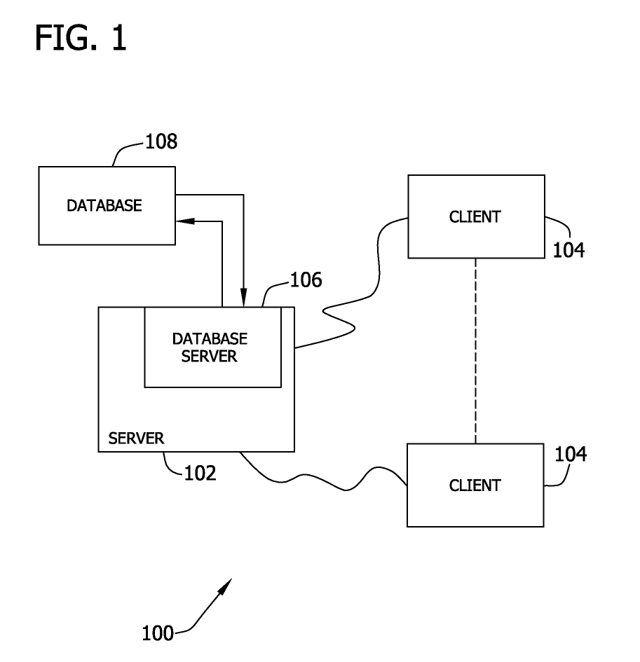

FIG. 1 is a simplified block diagram of an exemplary system 100 in accordance with one embodiment. In the exemplary embodiment, system 100 includes a server system 102, and a plurality of client sub-systems, also referred to as client systems 104, connected to server system 102. In one embodiment, client systems 104 are computers including a web browser and/or a client software application, such that server system 102 is accessible to client systems 104 over a network, such as the Internet and/or an intranet. Client systems 104 are interconnected to the Internet through many interfaces including a network, such as a local area network (LAN), a wide area network (WAN), dial-in-connections, cable modems, wireless modems, and/or special high-speed Integrated Services Digital Network (ISDN) lines. As described above, client systems 104 may be any device capable of interconnecting to the Internet including a computer, web-based phone, personal digital assistant (PDA), or other web-based connectable equipment. A database server 106 is connected to a database 108 containing information on a variety of matters, such as financial transaction card payment data. In one embodiment, centralized database 108 is stored on server system 102 and is accessed by potential users at one of client systems 104 by logging onto server system 102 through one of client systems 104. In an alternative embodiment, database 108 is stored remotely from server system 102 and may be non-centralized.

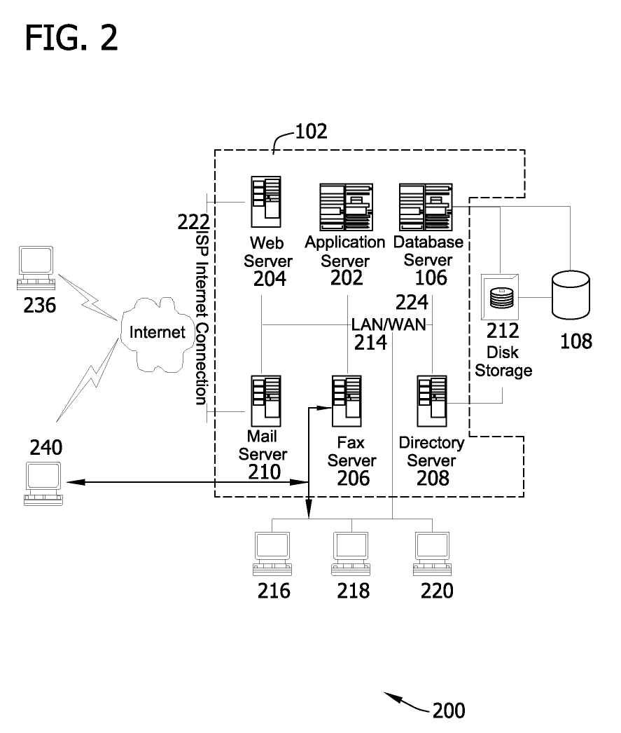

FIG. 2 is an expanded block diagram of an exemplary embodiment of a system architecture 200 of a system 100 (shown in FIG. 1) in accordance with one embodiment of the present invention. Components in system architecture 200, identical to components of system 100, are identified in FIG. 2 using the same reference numerals as used in FIG. 1. System 200 includes server system 102 and client systems 104. Server system 102 further includes database server 106, an application server 202, a web server 204, a fax server 206, a directory server 208, and a mail server 210. A disk storage unit 212 is coupled to database server 106 and directory server 208. Examples of disk storage unit 212 include, but are not limited to including, a Network Attached Storage (NAS) device and a Storage Area Network (SAN) device. Database server 106 is also coupled to database 108. Servers 106, 202, 204, 206, 208, and 210 are coupled in a local area network (LAN) 214. Client systems 104 may include a system administrator workstation 216, a user workstation 218, and a supervisor workstation 220 are coupled to LAN 214. Alternatively, client systems 104 may include workstations 216, 218, and 220 that are coupled to LAN 214 using an Internet link or are connected through an intranet.

Each client system 104, including workstations 216, 218, and 220, is a personal computer having a web browser and/or a client application. Server system 102 is configured to be communicatively coupled to client systems 104 to enable server system 102 to be accessed using an Internet connection 222 provided by an Internet Service Provider (ISP). The communication in the exemplary embodiment is illustrated as being performed using the Internet, however, any other wide area network (WAN) type communication can be utilized in alternative embodiments, that is, the systems and processes are not limited to being practiced using the Internet. In addition, and rather than WAN 224, local area network 214 may be used in place of WAN 224. Furthermore, fax server 206 may communicate with remotely located client systems 104 using a telephone link.

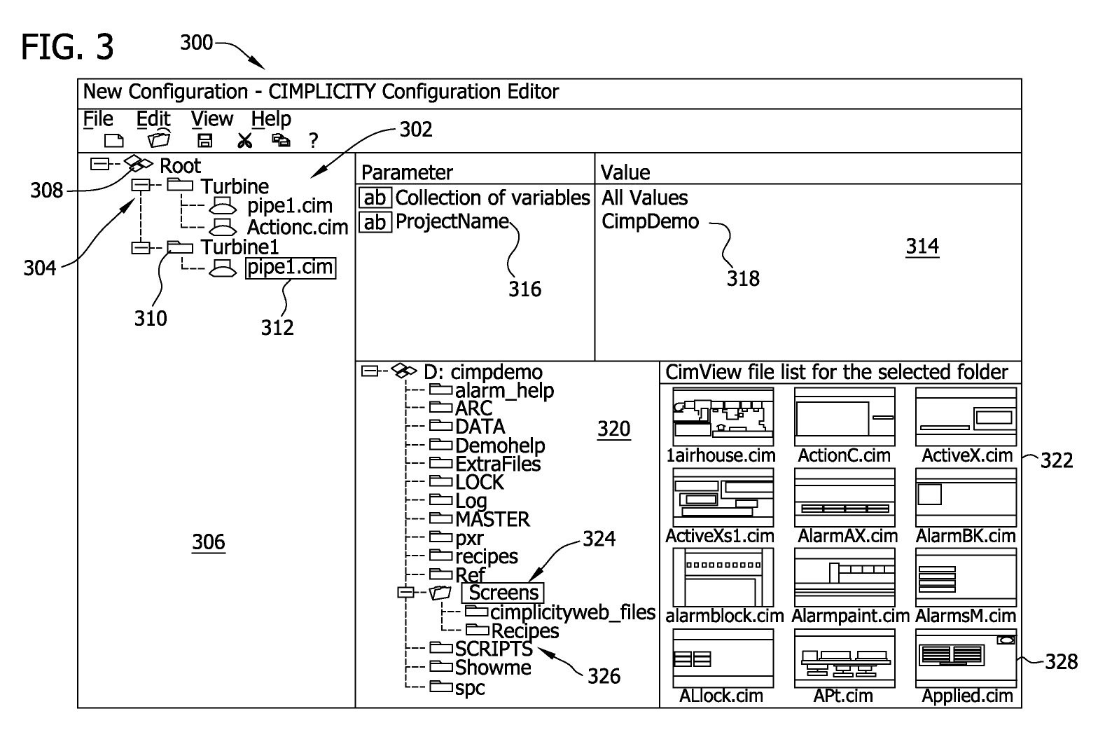

FIG. 3 is a diagram showing an exemplary configuration interface 300 utilized by system architecture 200 (shown in FIG. 2). More specifically, configuration interface 300 is utilized by client system 104 (shown in FIGS. 1 and 2) to create and/or modify a navigation tree of user screens. In the exemplary embodiment, configuration interface 300 enables a user to build a navigation tree 302 that includes a plurality of nodes 304. Configuration interface 300 includes a navigation tree frame 306 that displays nodes 304. Nodes 304 includes a root node 308, a plurality of parent nodes 310, and a plurality of leaf nodes 312. Root node 308 is a parent node of every node 304. Within navigation tree 302 and, as such, every node 304 within navigation tree 302 inherits properties from root node 308. Each parent node 310 includes additional parent nodes 310 and/or one or more leaf nodes 312. As such, each descendent parent node 310 and/or leaf node 312 inherits properties from its parent node 310. Alternatively, properties for each parent node 310 and/or each leaf node 312 may be manually set by a user via configuration interface 300 by creating a configuration file. A configuration file may be used by more than one node 304. In addition, each parent node 310 may be associated with a global system script. Each leaf node 312 has no descendents and is associated with a user screen and/or global system script.

In the exemplary embodiment, configuration interface 300 also includes a property frame 314. Property frame 314 includes, for example, a parameter column 316 that lists parameter names for a selected node 304, such as root node 308, parent node 310, or leaf node 312. Property frame 314 also includes a value column 318 that lists a parameter value for an associated parameter name in parameter column 316. Each node 304 includes one or more parameters that may be inherited from a parent node 310 or set by a user via configuration interface 300. Alternative embodiments may also include a description column (not shown) that lists a description for an associated parameter name.

Moreover, in the exemplary embodiment, configuration interface 300 includes a location frame 320 and a preview frame 322. Location frame 320 displays a user screen configuration file storage location 324 and a global system script configuration file storage location 326. When user screen configuration file storage location 324 is selected, preview frame 322 displays a thumbnail image 328 of each user screen as determined by a configuration file. Alternatively, preview frame 322 may display a list of configuration files organized by, for example, filename or date created. When a configuration file is selected from preview frame 322, properties of the associated node 304 are displayed in property frame 314 including parameter names and parameter values.

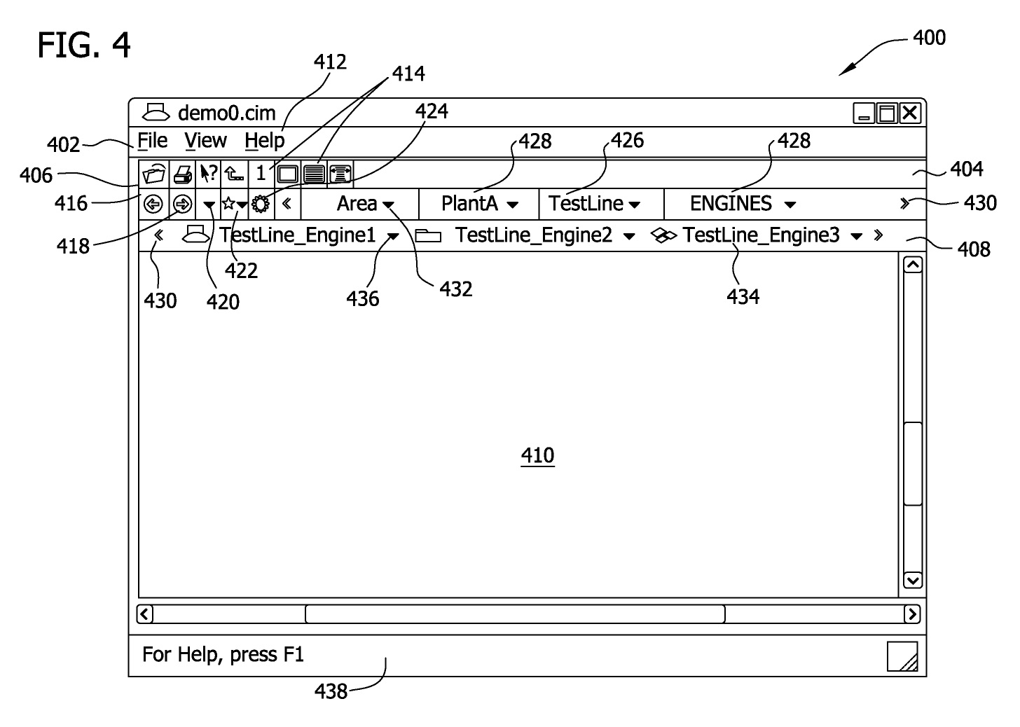

FIG. 4 is a diagram showing an exemplary user interface 400 utilized by system architecture 200 (shown in FIG. 2). More specifically, user interface 400 is utilized by client system 104 (shown in FIGS. 1 and 2). User interface 400 enables a user to monitor and/or control a system and/or a facility, such as a power plant or a manufacturing plant. In the exemplary embodiment, user interface 400 includes a menu bar 402, a function bar 404, a navigation bar 406, a child bar 408, and a display area 410. Menu bar 402 includes one or more user-actuated menus 412 that drop down to display options or functions available to a user. For example, as shown in FIG. 4, menu bar 402 includes a File menu, a View menu, and a Help menu. Alternative embodiments of user interface 400 may include additional menus and/or may replace the menus shown with different menus. In the exemplary embodiment, function bar 404 includes one or more icon buttons 414. Each icon button 414 represents a function available to a user, such as printing, opening a file, and/or viewing help files.

In the exemplary embodiment, navigation bar 406 includes a back button 416, a forward button 418, and a recently viewed drop down button 420. Back button 416, when selected by a user, navigates to a previously viewed user screen. Similarly, after navigating to a previously viewed user screen using back button 416, forward button 418 navigates to a subsequently viewed user screen. Both back button 416 and forward button 418 are enabled only when a node is available for the action. For example, if a user has not yet navigated to a previously viewed user screen using back button 416, then forward button 418 is not enabled. Drop down button 420 enables a user to select from a list of recently viewed user screens in display area 410 and/or recently selected nodes. Moreover, navigation bar 406 includes a favorite list drop down button 422 and an indicator 424. Favorite list drop down button 422 enables a user to select and automatically navigate to a commonly accessed node. More specifically, favorite list drop down button 422 includes a list of user-defined favorite nodes, an “Add To Favorites” function, an “Organize Favorites” function, and a “Set Default Path” function. The “Add to Favorites” function adds a currently selected node to the favorites list. The “Organize Favorites” function enables the user to modify a displayed order of nodes within the favorites list, to delete a node from the favorites list, and/or to set a particular node within the favorites list as a default node to be displayed upon initiation of user interface 400. The “Set Default Path” function sets a navigation path of a currently selected node to be a default navigation path for the currently selected node in the future. Indicator 424 is displayed on navigation bar 406 when a currently displayed user screen has not been registered with navigation tree 302 (shown in FIG. 3) using configuration interface 300 (shown in FIG. 3). In one embodiment, navigation bar 406 also includes one or more quick launch buttons (not shown) that are configured by a user via configuration interface 300. Each quick launch button facilitates a quick access to a particular user screen or global system script.

Further, in the exemplary embodiment, navigation bar 406 includes a current path 426, which includes one or more node buttons representative of an ancestry line of parent nodes 428 of a currently selected node. Clicking any node within current path 426 invokes the user screen or global system script associated with the clicked node. Display area 410 is blank if a node is selected from current path 426 that is not associated with a user screen. Moreover, navigation bar 406 may include one or more shift buttons 430 when current path 426 is wider than a current window size of user interface 400. Using shift buttons 430 enables a user to scroll to a first, or left-most, node of current path 426 or to a last, or right-most, node of current path 426. Further, each parent node 428 in current path 426 includes a drop down button 432. Clicking drop down button 432 associated with a particular parent node 428 displays a list of all child nodes associated with parent node 428 according to navigation tree 302.

In the exemplary embodiment, child bar 408 includes one or more leaf nodes 434 of a currently selected node. If a leaf node 434 shown on child bar 408 is associated with a user screen, and one or more other nodes are associated with the same user screen, a drop down button 436 is displayed. Clicking drop down button 436 associated With leaf node 434 displays a list of other nodes that are associated with the user screen. Choosing any node within the list operates to navigate to the chosen node. Moreover, child bar 408 may include one or more shift buttons 430 when a number of leaf nodes 434 of a currently selected node is wider than the current window size of user interface 400. Using shift buttons 430 enables a user to scroll to a first, or left-most, node of child bar 408 or to a last, or right-most, node of child bar 408.

In the exemplary embodiment, display area 410 is used to display a user screen associated with a chosen node. In an alternative embodiment, display area 410 is used to display output and/or errors produced by a global system script. Moreover, user interface 400 includes a status bar 438.

In the exemplary embodiment, tool tips are used to display a description of a node. For example, when a user moves a cursor over a node, a description of the node is displayed. Such a description is also displayed in status bar 438. For nodes that do not have an assigned description, there is no description displayed in a tool tip and/or in status bar 438.

In one embodiment, a user is assigned a set of access permissions by, for example, a system administrator. The access permissions limit the user to accessing a subset of navigation tree 302. For example, the user may be limited to accessing a particular ancestry path, including a particular leaf node 434 and any parent nodes 428 of the particular leaf node 434. In an alternative embodiment, a computer is assigned a set of access permissions. Based on the assigned permissions, a user using the computer is limited to accessing a subset of navigation tree 302. In a further alternative embodiment, when a user with limited access permissions uses a computer With limited access permissions, the user is limited to accessing only those subsets of navigation tree 302 allowed by the permissions assigned to both the user and the computer.

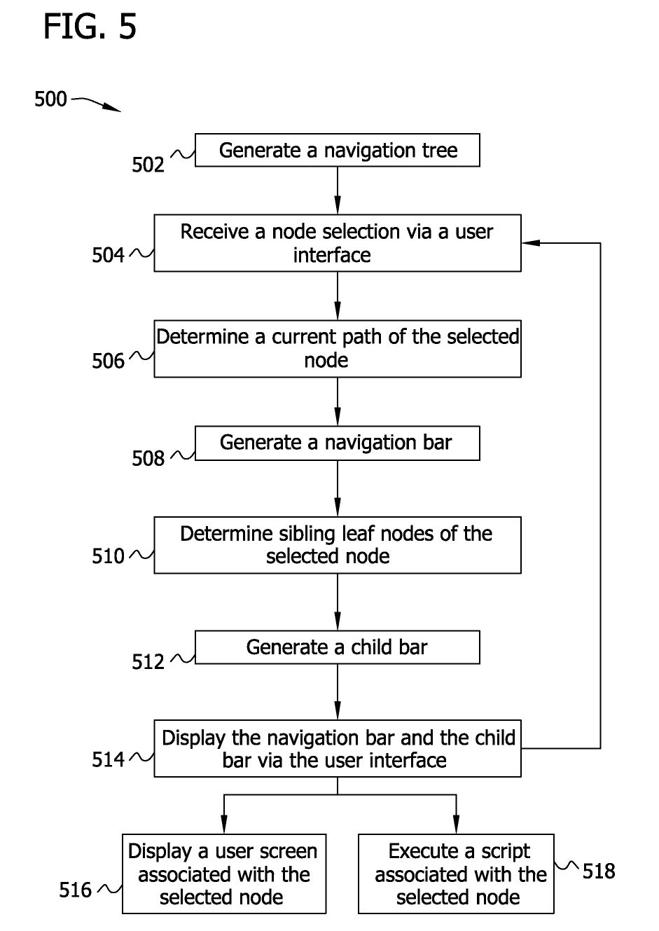

FIG. 5 is a flowchart illustrating an exemplary method 500 utilized by system architecture 200 (shown in FIG. 2) for displaying hierarchical information related to a plurality of user screens. More specifically, in the exemplary embodiment, method 500 is utilized by a particular client system 104 (shown in FIGS. 1 and 2) of system 200 to generate and display such hierarchical information. In an alternative embodiment, client system 104 communicates with server system 102 (shown in FIGS. 1 and 2) to execute method 500. In the exemplary embodiment, navigation tree 302 (shown in FIG. 3) is generated 502. For example, navigation tree 302 may be generated by loading a plurality of user screen configuration files and/or global system script configuration files using configuration interface 300 (shown in FIG. 3). Configuration interface 300 may also be used to create new configuration files. When navigation tree 302 has been created, configuration interface 300 may then be used to configure navigation tree 302. For example, a user may modify properties for a particular node such that the new properties are used for display of an associated user screen rather than properties inherited by a parent node. In one embodiment, navigation tree 302 is stored. For example, navigation tree 302 may be stored as an Extensible Markup Language (XML) file. The XML file may be stored on client system 104 or may be stored within server system 102 such that the XML file is accessible by client system 104. Alternative embodiments may store navigation tree 302 as a different file type or within database 108 (shown in FIG. 1) such that navigation tree 302 is accessible by client system 104.

When navigation tree 302 is generated and configured, a user may interact with navigation tree 302 using user interface 400 (shown in FIG. 4) as displayed by client system 104. In one embodiment, the user logs in via user interface 400, and client system 104 determines a set of access permissions granted to the user related to nodes within navigation tree 302. In an alternative embodiment, a set of access permissions are granted to a particular client system 104 such that any user logged into client system 104 is limited to a subset of nodes within navigation tree 302. Client system 104 determines a default node to be displayed to the user upon logging in via display area 410 (shown in FIG. 4). The default node may be set by an administrator with sufficient permissions using configuration interface 300. When client system 104 receives 504 a node selection by the user via user interface 400, client system 104 determines 506 current path 426 (shown in FIG. 4) of the selected node. Navigation bar 402 is generated 508, including back button 416, forward button 418, recently viewed drop down 420, favorite list drop down 422, and/or one or more quick access buttons (each shown in FIG. 4). When generated by client system 104, navigation bar 402 also includes current path 426 (shown in FIG. 4). In an alternative embodiment, client system 104 communicates the node selection to server 102, and server 102 determines current path 426 of the selected node. Server 102 communicates current path 426 to client system 104, and client system 104 generates navigation bar 406.

Moreover, in the exemplary embodiment client system 104 determines 510 one or more sibling leaf nodes (shown in FIG. 4) of the selected node, such that each sibling leaf node and the selected node have a common parent node. Client system 104 then generates 512 child bar 408 (shown in FIG. 4) including a node button 434 for each sibling leaf node. Moreover, client system 104 determines whether each sibling leaf node is associated with a user screen. If a sibling leaf node is associated with a user screen, client system 104 displays a drop down button 436 that displays a list of additional nodes associated with the same user screen.

In the exemplary embodiment, client system 104 then displays 514 navigation bar 406 and child bar 408 via user interface 400. Moreover, in the exemplary embodiment, if the selected node is associated with a user screen, client system 104 displays 516 the user screen in display area 410. Alternatively, if the selected node is associated with a global system script, client system 104 communicates with, for example, server 102 and/or a machine that executes 518 the script.

A user may select a different node from among quick access buttons, current path 426, child bar 408, recently viewed drop down 420, favorite list drop down 422, and drop down buttons 432 or 436. When a different node is selected, client system 104 determines 506 current path 426 of the newly selected node, generates 508 navigation bar 406, determines 510 sibling nodes of the newly selected node, generates 512 child bar 408, displays 514 navigation bar 406 and child bar 408, and displays 516 an associated user screen or executes 518 an associated script. In an alternative embodiment, client system 104 and/or server 102 may determine sibling nodes of a selected node prior to or concurrently with determining a current path. Similarly, client system 104 and/or server 102 may generate child bar 408 prior to or concurrently with generating navigation bar 406.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for displaying hierarchical information related to a plurality of user screens, said method comprising:
generating a navigation tree including a plurality of nodes, each node of the plurality of nodes including at least one of a link to a user screen of the plurality of user screens, a pointer to at least one parent node of the plurality of nodes, and a link to a script;
generating a navigation bar including a plurality of node navigation tool buttons and a current path including at least a first node button representative of a currently selected first node of the pluralist of nodes;
generating a child bar including at least the first node button; and
displaying the navigation bar and the child bar within a user interface.

2. A method in accordance with claim 1, further comprising:
receiving a selection of a second node of the plurality of nodes;
re-generating the navigation bar such that the current path includes at least a second node button representative of the second node;
re-generating the child bar such that the child bar includes at least the second node button; and
displaying the navigation bar and the child bar within the user interface.

3. A method in accordance with claim 2, further comprising:
receiving a command to return to a previously selected first node of the plurality of nodes;
re-generating the navigation bar such that the current path includes at least the first node button representative of the first node;
re-generating the child bar such that the child bar includes at least the first node button; and
displaying the navigation bar and the child bar within the user interface.

4. A method in accordance with claim 1, wherein generating a navigation bar comprises determining the current path based on a position of the first node within the navigation tree such that the current path includes at least one second node button representative of a second node of the plurality of nodes, the first node being a child of the second node.

5. A method in accordance with claim 4, wherein generating a child bar comprises determining a number of sibling nodes of the first node such that the child bar includes the first node button and a node button representative of each sibling node of the number of sibling nodes, wherein each sibling node is a child of the second node.

6. A method in accordance with claim 5, wherein displaying the navigation bar and the child bar within the user interface comprises adjusting a display width of the navigation bar and the child bar based on a number of displayed node buttons.

7. A method in accordance with claim 1, further comprising configuring the navigation tree such that a particular node of the plurality of nodes is set to be a child node of multiple nodes of the plurality of nodes.

8. A method in accordance with claim 1, wherein generating a navigation tree comprises storing the navigation tree as an Extensible Markup Language (XML) file.

9. A method in accordance with claim 1, further comprising determining permissions issued to a user such that at least one of the navigation bar and the child bar is generated based on the issued permissions.

10. A method in accordance with claim 1, further comprising determining permissions issued to a computer such that at least one of the navigation bar and the child bar is generated base on the issued permissions.

11. A computer for displaying a plurality of user screens through a human-machine interface (HMI), said computer programmed to:
generate a navigation tree including a plurality of nodes, each node of the plurality of nodes being at least one of a link to a user screen of the plurality of user screens, a pointer to at least one parent node of the plurality of nodes, and a link to a script;
generate a navigation bar including a plurality of node navigation tool buttons and a current path including at least a first node button representative of a currently selected first node of the plurality of nodes;
generate a child bar including at least the first node button; and
display the navigation bar and the child bar within a user interface.

12. A computer in accordance with claim 11, further programmed to:
receive a selection of a second node of the plurality of nodes through the user interface;
re-generate the navigation bar such that the current path includes at least a second node button representative of the second node;
re-generate the child bar such that the child bar includes at least the second node button; and
display the navigation bar and the child bar within the user interface such that a display width of the navigation bar and a display width of the child bar are based on a number of displayed node buttons.

13. A computer in accordance with claim 12, further programmed to:
receive a command through the user interface to return to a previously selected first node of the plurality of nodes;
re-generate the navigation bar such that the current path includes at least the first node button representative of the first node;
re-generate the child bar such that the child bar includes at least the first node button; and
display the navigation bar and the child bar within a user interface such that a display width of the navigation bar and a display width of the child bar are based on a number of displayed node buttons.

14. A computer in accordance with claim 11, further configured to determine the current path based on a position of the first node within the navigation tree and to generate the navigation bar such that the current path includes at least one second node button representative of a second node of the plurality of nodes, wherein the first node is a child of the second node.

15. A computer in accordance with claim 14, further configured to determine a number of sibling nodes of the first node and to generate the child bar such that the child bar includes the first node button and a node button representative of each sibling node of the number of sibling nodes, wherein each sibling node is a child of the second node.

16. A computer program embodied on a computer readable medium for displaying a plurality of user screens through a human-machine interface (HMI), said program comprising at least one code segment that:
generates a navigation tree including a plurality of nodes, each node of the plurality of nodes being at least one of a link to a user screen of the plurality of user screens, a pointer to at least one parent node of the plurality of nodes, and a link to a script;
generates a navigation bar including a plurality of node navigation tool buttons and a current path including at least a first node button representative of a currently selected first node of the plurality of nodes;
generates a child bar including at least the first node button; and
displays the navigation bar and the child bar within a user interface such that a display width of the navigation bar and a display width of the child bar are based on a number of displayed node buttons.

17. A computer program in accordance with claim 16, further comprising at least one code segment that:
receives a selection of a second node of the plurality of nodes through the user interface;
re-generates the navigation bar such that the current path includes at least a second node button representative of the second node;
re-generates the child bar such that the child bar includes at least the second node button; and
displays the navigation bar and the child bar within a user interface such that a display width of the navigation bar and a display width of the child bar are based on a number of displayed node buttons.

18. A computer program in accordance with claim 17, further comprising at least one code segment that:
receives a command through the user interface to return to a previously selected first node of the plurality of nodes;
re-generates the navigation bar such that the current path includes at least the first node button representative of the first node;
re-generates the child bar such that the child bar includes at least the first node button; and
displays the navigation bar and the child bar within a user interface such that a display width of the navigation bar and a display width of the child bar are based on a number of displayed node buttons.

19. A computer program in accordance with claim 16, further comprising at least one code segment that determines the current path based on a position of the first node within the navigation tree and generates the navigation bar such that the current path includes at least one second node button representative of a second node of the plurality of nodes, wherein the first node is a child of the second node.

20. A computer program in accordance with claim 19, further comprising at least one code segment that determines a number of sibling nodes of the first node and generates the child bar such that the child bar includes the first node button and a node button representative of each sibling node of the number of sibling nodes, wherein each sibling node is a child of the second node.
